(19) United States
(12) Patent Application Publication
(10) Pub. No.: US 2021/0386536 A1
(43) Pub. Date: Dec. 16, 2021

(54) DEVICE AND METHOD FOR DETERMINING THE RELATIVE POSITIONS OF AN UPPER AND LOWER JAW

(71) Applicant: a.tron3d GmbH, Klagenfurt am Woerthersee (AT)

(72) Inventor: Juergen JESENKO, Riegersdorf (AT)

(21) Appl. No.: 17/341,840

(22) Filed: Jun. 8, 2021

(30) Foreign Application Priority Data
Jun. 10, 2020 (EP) 20 179 315.5

(51) Int. Cl. A61C 19/04; A61C 13/00; A61C 13/36; A61C 13/28

(52) U.S. Cl. CPC A61C 19/04; A61C 13/28; A61C 13/1016; A61C 13/0004

(57) ABSTRACT

A device for determining the relative positions of an upper and lower jaw has an upper carrier with an upper contact surface for the upper jaw and a lower carrier with a lower contact surface for the lower jaw, wherein the carriers in a position of use correspond to the device with an upper jaw and a lower jaw. In addition, the device has a system for detecting the relative spatial positions of the upper and lower carriers with respect to one another.

### BACKGROUND OF THE INVENTION

### Field of the Invention

The invention relates to a device for determining the relative positions of an upper and lower jaw.

The invention further relates to a computer-implemented method for operating a device for determining the relative positions of an upper and lower jaw.

### Description of the Related Art

In the state of the art, various methods are known for determining the relative positions of jaws when the latter also hold significant parts of the dentition. In this case, the remaining teeth have a crossbite in one or more locations and then are detected either in an analog manner (for example by a dental impression) or in a digital manner, for example by a bite scan (see, for example, EP 3 444 780 A1).

If, however, there are no longer enough teeth that can interlock for a bite, no bite can be detected any longer, either.

In analog dental technology, to create a denture in a sequence of multiple dental or gum impressions, a possible jaw spacing can then be determined, which then serves as a basis for a (re)constructed bite. This method is very time- and material-intensive and in addition not very precise.

In digital dental technology, no methods are known for determining jaw spacing for the reconstruction or new construction of a bite when not enough teeth are present for an interlocking bite.

### SUMMARY OF THE INVENTION

It is therefore the object of the invention to offer an improved option for detecting jaw spacing, in particular for detecting jaw spacing in the case where there is little or no dentition of the jaw.

This object is achieved with a device as well as with a method disclosed and claimed herein.

The basic design of the device according to the invention has three decisive elements: first of all, there is an upper contact surface, which is arranged on an upper carrier and corresponds to the upper jaw in the position of use or adjoins the gum that is located on the upper jaw. Secondly, there is a lower contact surface that is arranged on a lower carrier and corresponds to the lower jaw in the position of use, or adjoins the gum that is located on the lower jaw. And thirdly, there is a connecting piece that can be designed in various ways and can detect the relative positions of the two carriers to one another. This detection can be carried out quite simply mechanically, for example in the form of sliding calipers, or else digitally. The carriers can be connected, for example, via a joint, in particular a ball joint, whose position is detected.

Both for the carrier and for the connection between the carriers, there are various advantageous embodiments that individually and/or in combination improve the invention.

The carriers themselves can have recesses that correspond to intraoral structures. The intraoral structures can be, for example, remaining teeth or abutments of implants that could prevent a uniform contact of the contact surfaces on the gum. In order to create carriers especially adapted to the respective intraoral situation, the respective jaw arches can be scanned beforehand or can have been detected with a physical impression.

Another advantageous embodiment of the carrier can include that the latter are manufactured from an elastic material at least in places. As a result, the use of the device for the individual whose bite is to be reconstructed can be made more comfortable. Of course, a possible compression of the material has to be taken into consideration when detecting the positions of the upper and lower jaw.

In order to support an easy and safe use of the device, according to a preferred embodiment, the carriers are spring cushioned against one another. According to a further development of this embodiment, the loading of the suspension can be detected at one or more points. This information can be used to support an especially ergonomic bite reconstruction. As a result, tensions in the jaw musculature, headaches, and other negative effects can be avoided, which can develop when using dentures. In this case, the suspension can be designed both in the form of conventional springs, such as coil springs, clamp springs, or spiral springs, and by the use of compressible materials, such as elastic compressible polymers and compressible fluids. Fluids that are moved between chambers and have a retarding effect, for example by special valves or tight connections with little leakage, are also conceivable.

In particular, when the acquired relative position is to be recorded in analog form, it is advantageous when the two carriers can be fixed to one another in their relative positions. Accordingly, the carriers can be locked in their relative positions to one another according to another preferred embodiment of the device.

In order to determine the relative position of the jaw, the device according to the invention has a system for detecting the relative spatial positions of the upper and lower carriers with respect to one another. Three possible embodiments for the configuration of this system are described below.

In a first embodiment of the system for detecting the spatial position of the carriers, the device has distance meters at at least three known points, which detect the distance between the carriers. The latter can be fully analog and work like vernier calipers. In an exclusively analog embodiment, the values from the distance meters can be read and noted by an operator in order to be further processed later.

In an alternative embodiment, the distances can also be detected electronically, for example with capacitive distance meters. Of course, such acquired values can also be easily displayed and recorded. The possibility of transmitting these values to a computer unit and using them for computer-supported design of a denture also exists, however.

In a second embodiment of the system for detecting the spatial position of the carriers, the carriers are connected to a multi-directional joint, in particular a ball joint, and the system detects a location of the ball joint. This can be done, for example, by simple markings on the ball joint. As an alternative, for example, rotary coders, such as in the case of very early variants of computer mice, can also be used.

In a third possible embodiment of the invention, fluid-filled chambers can be provided between the carriers. If the carriers are brought close to one another, the fluid is displaced in the chambers. The displaced fluid can then be detected by a volume-measuring device. The detection can, as also in the other cases, be done both in an analog manner and in a digital manner. As a simple example of an analog measurement, for example, cavities with readable scales, comparable to a syringe, are conceivable. It is also conceivable, however, to detect the movement of the fluid by means of a digital flowmeter.

According to another embodiment of the invention, the two carriers can also each have a position sensor. When the positions of the two carriers in space are known precisely enough, the relative positions of the carriers to one another are also known. The advantage of such an embodiment is that it is easier to mount the carriers with respect to one another mechanically.

Independently of the mechanical configuration of the system for detecting the spatial position of the carriers, as further described above, electronic or digital information can be generated via the relative spatial position of the carriers. Several possibilities exist to transmit these data for further processing to a computer unit or to configure a means for transmitting data, which the device preferably has.

In a first embodiment, the means for transmitting data can be a suitable cable that connects the device to a computer unit. This variant is primarily simple and economical to create.

In a second embodiment, the means for transmitting data can be a transmitter or transceiver, which produces a wireless connection to a computer unit. This facilitates the handling of the device, since a connecting cable does not have to be taken into account.

In all embodiments that do not use a cable, with which the device can also be supplied with power, it is useful to provide the device in addition with an electric power storage unit. The latter can be arranged in, for example, the carriers.

A special embodiment of the invention, which requires only a very weak power storage unit, but in this case simultaneously offers the convenience that it does not have a cable, has a data storage unit in the device, since no power is thus required for the transmission, but rather only for the detection and storage.

If the device has a data storage unit, the latter can be read, after the relative position was measured and stored. This can be done by the data storage unit being removed from the device and placed in a corresponding reading device or else by the device being plugged via a corresponding connection into a corresponding computer unit or transmission system.

The method according to the invention includes at least the following steps:
a. Determining the spatial position in the form of measuring data,
b. Transmitting the position of the measuring data to a computer unit,
c. Making available 3D models of an upper jaw and a lower jaw,
d. Combining measuring data and the available 3D models of an upper jaw and lower jaw to establish a three-dimensional, relative, spatial position, and
e. Depicting the upper jaw and lower jaw in the three-dimensional, relative, spatial position.

Step a. is preferably carried out with a device according to the invention. Step b. can also be carried out with one of the preferred embodiments of the invention, in particular the described means for transmitting data.

In step c., the 3D models of an upper jaw and a lower jaw are loaded. According to a preferred implementation of the method, the 3D models were created with an intraoral 3D scanner. According to another preferred implementation of the method, the 3D models are physical impressions of the upper jaw and/or lower jaw that are digitized by means of a 3D scanner.

Step c. can, of course, also be carried out at an earlier time. It is essential that for step d., both the 3D models of the upper jaw and lower jaw and the information with respect to the spatial position be available to a computer unit.

In step d., the 3D models and the positions, specifically the information about the spatial position, are combined and then depicted in a step e.

Additional preferred embodiments of the invention are the subject matter of the other subclaims.

### BRIEF DESCRIPTION OF THE DRAWINGS

Below, a preferred embodiment of the invention is described in more detail based on the drawings. For the sake of greater clarity, similar components in various figures and/or embodiments are provided with the same reference numbers. Here:

FIGS. 1a-1d show a first embodiment of the device in a first position,

FIGS. 2a-2d show the first embodiment in a second position,

FIGS. 3a-3d show the first embodiment in a third position,

FIGS. 4a-4d show a second embodiment of the device in a first position,

FIGS. 5a-5d show the second embodiment in a second position,

FIGS. 6a-6d show the second embodiment in a third position,

FIG. 7 shows a third embodiment in a position as in FIGS. 2a-2d, and

FIG. 8 shows an implementation of the method according to the invention.

### DESCRIPTION OF THE PREFERRED EMBODIMENTS

In the figures, two possible embodiments of the invention are shown in a roughly schematized way from various viewpoints and in various positions.

All depicted embodiments in each case have an upper carrier 1 with an upper contact surface 2 and a lower carrier 3 with a lower contact surface 4.

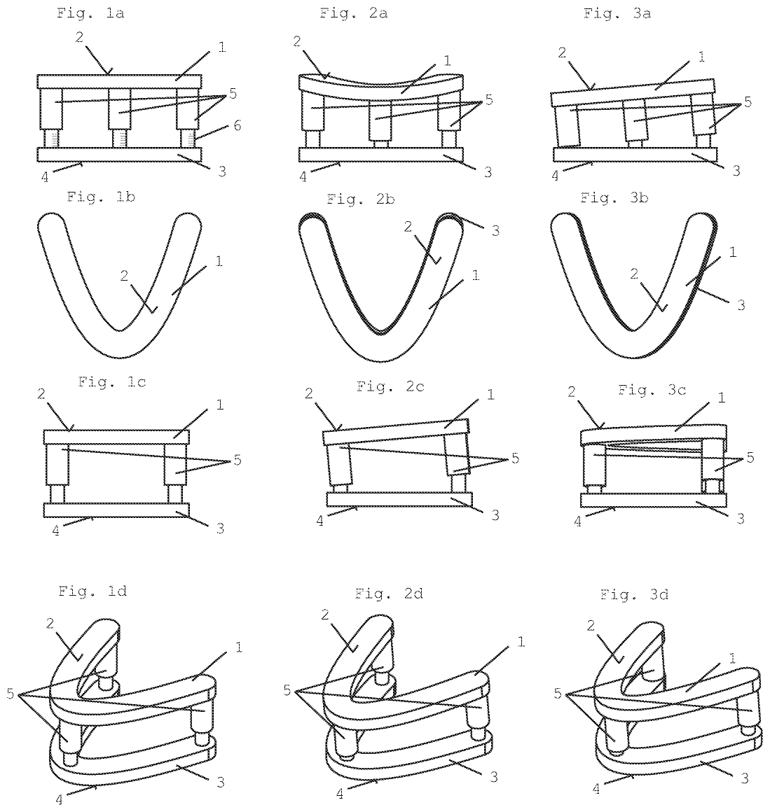

In FIGS. 1 to 3, a first embodiment is depicted, in which distance meters 5 are arranged between the carriers 1, 3 at three points. These distance meters 5 can be both analog and electronic. For a very simple implementation, for example, scales 6 (see FIG. 1) can be provided, which can be read by an operator.

The distance meters 5 can also operate electronically, however, for example with capacitive distance meters or based on piezoelectric crystals.

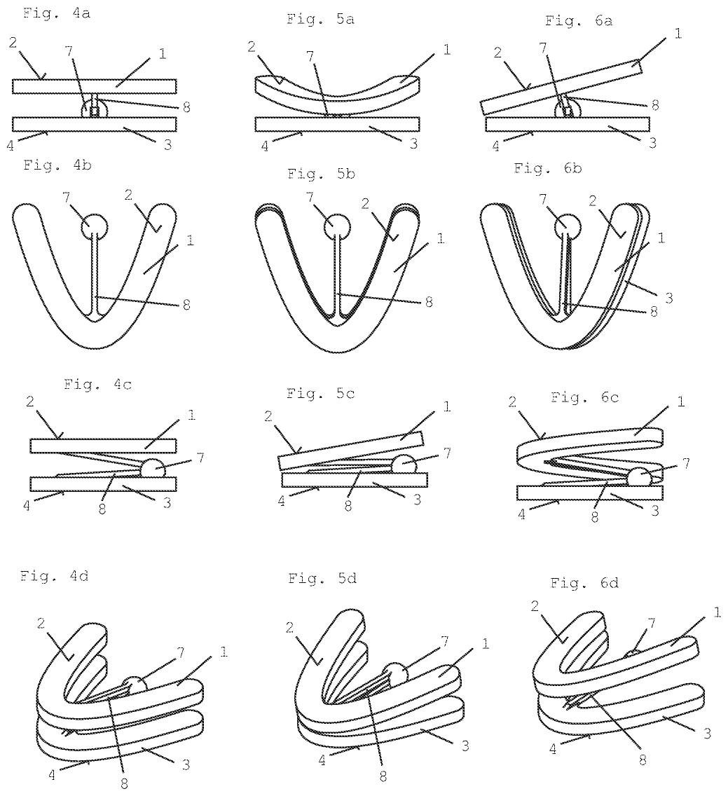

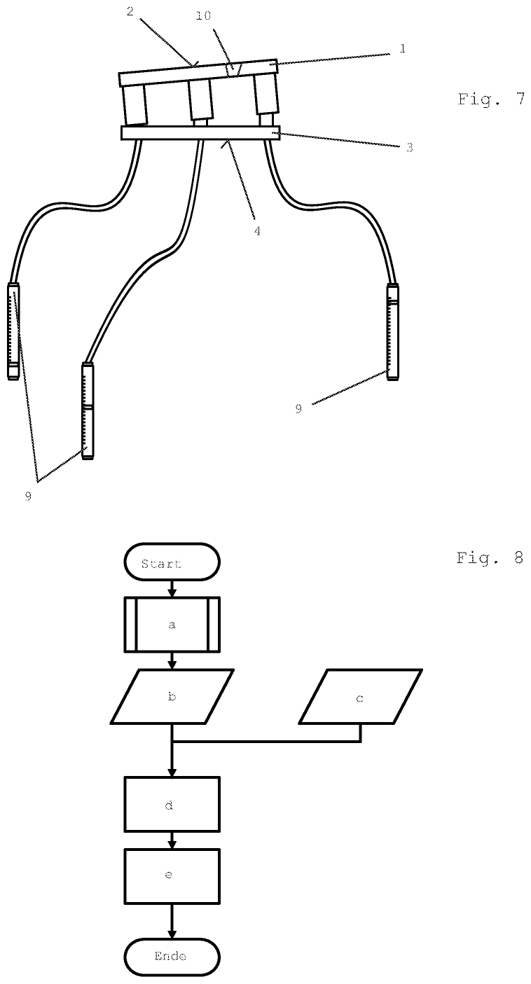

In FIGS. 4 to 6, a second embodiment is depicted, in which the carriers 1, 3 are connected to a ball joint 7. The latter is advantageously arranged eccentrically and connected via arms 8 to the carriers 1, 3.

When the position of the ball joint 7 is detected electronically, a power source, for example a battery or a accumulator, can be arranged in one or both carriers 1, 3, and the arms 8 can produce a connection between the power sources in the carriers 1, 3 and sensors in the ball joint 7.

In addition, it is clear that the ball joint 7 in the second embodiment is arranged far outside the geometric center of the device. As a result, the carriers 1, 3 are able to approach one another, which requires a correct detection of the relative positions of the upper and lower jaw.

The device that is shown in FIG. 7 is designed similar to that of FIGS. 1 to 3 and in a position and viewpoint as in FIG. 3a. However, the carriers 1, 3 are mounted so that a fluid can be displaced from the chambers between the carriers. The displaced fluid can then be measured with, for example, scales 9.

FIG. 7 further shows a recess 10 in the upper carrier. In this recess, for example, a remaining tooth can engage in the upper jaw. However, it is also possible, for example, for a healing abutment for an implant to be located at the corresponding point in the jaw.

FIG. 8 illustrates a method according to the invention. In step a, measurement data about the relative spatial position of the carriers are captured and then made available in step b for the subsequent process. In step c, in addition, data with respect to intraoral structures are made available. The latter can have been obtained with, for example, an intraoral scanner. There is also the possibility, however, that impressions created conventionally in an analog manner have been digitized in order to generate data for step c. In step d, the data made available in steps b and c are merged and combined. In this case, an extended model is produced, which model takes into consideration both the intraoral structures and their spatial ratio. In step e, the extended model is then depicted.

1. Device for determining the relative positions of an upper and lower jaw, wherein the device has an upper carrier with an upper contact surface for the upper jaw and a lower carrier with a lower contact surface for the lower jaw, wherein in a position of use of the device the carriers correspond with an upper jaw and a lower jaw, and wherein the device has a system for detecting the relative spatial positions of the upper and lower carriers with respect to one another.

2. The device according to claim 1, wherein the system has distance meters at at least three measuring points, which meters detect the distance between the carriers.

3. The device according to claim 1, wherein the carriers are connected to a multi-directional joint, and wherein the system detects a position of the ball joint.

4. The device according to claim 1, wherein the system has fluid-filled chambers, which are connected to one another at least in part, as well as a means for detecting movements of fluid between connected chambers.

5. The device according to claim 1, wherein the system is digital and has a means for transmitting the detected, relative, spatial position.

6. The device according to claim 1, wherein the carriers have recesses that correspond to intraoral structures in the respective jaw.

7. The device according to claim 1, wherein the carriers are spring cushioned with respect to one another.

8. The device according to claim 7, wherein the device has a means for detecting the spring load between the carriers.

9. The device according to claim 1, wherein the carriers can be locked with respect to one another in their relative positions.

10. The device according to claim 3, wherein the device has a means for transmitting data.

11. The device according to claim 10, wherein the device has a means for wireless data transmission.

12. The device according to claim 3, wherein the device has a data storage unit.

13. The device according to claim 1, wherein the device includes at least one sensor for determining a change in position.

14. Computer-implemented method for operating a device with the features of claim 1 for determining the relative positions of an upper and lower jaw, wherein the method includes the following steps:
a. Determining positional data of the spatial position of the carriers in the form of measurement data,
b. Transmitting measurement data to a computer unit,
c. Making available 3D models of an upper jaw and a lower jaw,
d. Combining the measurement data and the 3D models of an upper jaw and lower jaw, which are made available to form a three-dimensional, relative, spatial position, and
e. Depicting the upper jaw and lower jaw in the three-dimensional, relative, spatial position.

15. The method according to claim 14, wherein the 3D models are digital impressions of the upper jaw and/or lower jaw that are created with an intraoral 3D scanner.

16. The method according to claim 14, wherein the 3D models are physical impressions of the upper jaw and/or lower jaw that are digitized with a 3D scanner.

17. The device of claim 3, wherein the multi-directional joint is a ball joint.

18. The device according to claim 2, wherein the system is digital and has a means for transmitting the detected, relative, spatial position.

19. The device according to claim 3, wherein the system is digital and has a means for transmitting the detected, relative, spatial position.

20. The device according to claim 4, wherein the system is digital and has a means for transmitting the detected, relative, spatial position.
